(19) United States
(12) Patent Application Publication
(10) Pub. No.: US 2026/0367400 A1
(43) Pub. Date: Nov. 19, 2026

(54) ENHANCED PUPIL REPLICATION USING FOLD GRATING FOR EYEPIECES IN NEAR-EYE DISPLAYS

(71) Applicant: Applied Materials, Inc., Santa Clara, CA (US)

(72) Inventors: Kevin MESSER, Mountain View, CA (US); Samarth BHARGAVA, Saratoga, CA (US)

(21) Appl. No.: 19/121,973

(22) PCT Filed: Oct. 27, 2023
(86) PCT No.: PCT/US2023/036106

§ 371 Date: Apr. 17, 2025

Related U.S. Application Data
(60) Provisional application No. 63/381,325, filed on Oct. 28, 2022.

(51) Int. Cl. G02B 27/01

(52) U.S. Cl. CPC G02B 27/0172; G02B 2027/0123; G02B 2027/0178

(57) ABSTRACT

Embodiments of the present disclosure relate to near-eye display systems with an increased exit pupil density. In one embodiment, a waveguide combiner is provided which includes a first surface, a second surface, an in-coupler located on the first surface, configured to receive a plurality of input beams and diffract a first subset of beams and a second subset of beams into total-internal-reflection (TIR) in two opposite directions in K-Space, a first fold grating located on the first surface, configured to receive the 2024/091654 first subset of beams from the in-coupler at a first region and diffract the first subset of beams to a second region, a second fold grating located on the first surface, configured to receive the second subset of beams from the in-coupler at a third region and diffract the second subset of beams to the second region, and a first out-coupler located on the first surface.

### BACKGROUND

### Field

Embodiments of the present disclosure generally relate to near-eye display systems, and, more specifically, to near-eye display systems with an increased exit pupil density as well as increased image sharpness and uniformity.

### Description of the Related Art

Virtual reality (VR) is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality (AR), however, enables an experience in which a user can still see through the display lenses of the glasses or other HMD device to view the surrounding environment, yet also see images of virtual objects that are generated for display and appear as part of the environment. AR can include any type of input, such as audio and haptic inputs, as well as virtual images, graphics, and video that enhance or augment the environment that the user experiences. As an emerging technology, there are many challenges and design constraints with augmented reality.

For waveguide combiners, of a near-eye display system, it is desirable to increase the density of exit pupils to the user eyebox. A conventional manner for increasing pupil density includes decreasing the thickness of a waveguide combiner. This reduction in thickness leads to an increase of in-coupled light reencountering the in-coupler causing a loss of image sharpness and quality and an increase in non-uniformity. If the substrate is thickened, a lower pupil density may create additional high-frequency non-uniformities due to sparsely replicated pupils which reach the user eyebox.

Accordingly, what is needed in the art are improved waveguide combiners.

### SUMMARY

In one embodiment, a waveguide combiner is provided. The waveguide combiner includes a first surface, a second surface, an in-coupler located on the first surface, configured to receive a plurality of input beams and diffract a first subset of beams and a second subset of beams into total-internal-reflection (TIR) in two opposite directions in K-Space, a first fold grating located on the first surface, configured to receive the first subset of beams from the in-coupler at a first region in K-Space and diffract the first subset of beams in TIR to a second region in K-Space, a second fold grating located on the first surface, configured to receive the second subset of beams from the in-coupler at a third region in K-Space and diffract the second subset of beams in TIR to the second region in K-Space, and a first out-coupler located on the first surface.

In another embodiment, a waveguide combiner is provided. The waveguide combiner includes a first surface, a second surface, an in-coupler located on the first surface, configured to receive a plurality of input beams and diffract the plurality of input beams into total-internal-reflection (TIR), a first replicator grating located adjacent to and below the in-coupler on the first surface, configured to receive the plurality of input beams from the in-coupler at a first region in K-Space and diffract the plurality of input beams in TIR to a second region in K-Space, a second replicator grating located adjacent to and below the first replicator grating on the first surface, a first out-coupler located adjacent to or below the second replicator grating on the first surface, and a second out-coupler located on the second surface.

In yet another embodiment, a waveguide combiner is provided. The waveguide combiner includes a first surface, a second surface, an in-coupler located on the first surface, configured to receive a plurality of input beams and diffract a first subset of beams and a second subset of beams into total-internal-reflection (TIR) in two opposite directions in K-Space, a first fold grating located on the first surface, configured to receive the first subset of beams from the in-coupler at a first region in K-Space and diffract the first subset of beams in TIR to a second region in K-Space, a second fold grating located on the first surface, configured to receive the second subset of beams from the in-coupler at a third region in K-Space and diffract the second subset of beams in TIR to the second region in K-Space, an out-coupler located on the first surface, configured to receive the first subset of beams from the first fold grating and the second subset of beams from the second fold grating at the second region in K-Space, diffract a first portion of the first subset of beams and the second subset of beams to a fourth region in K-Space, diffract a second portion of the first subset of beams and the second subset of beams to a fifth region in K-Space, out-couple a third portion of the first subset of beams and the second subset of beams from a sixth region, and out-couple a fourth portion of the first subset of beams and the second subset of beams from a seventh region in K-Space, and an expander grating located on the second surface, configured to receive the first portion of the first subset of beams and the second subset of beams from the first fold grating and the second fold grating at the second region in K-Space, diffract a third portion of the first subset of beams and the second subset of beams to the sixth region, diffract a fourth portion of the first subset of beams and the second subset of beams to the seventh region in K-Space, out-couple the first portion of the first subset of beams and the second subset of beams from the fourth region, and out-couple the second portion of the first subset of beams and the second subset of beams from the fifth region in K-Space.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a perspective view of a near-eye display system according to one or more embodiments of the present disclosure.

FIG. 2 illustrates a cross-sectional view of the near-eye display system of FIG. 1 according to one or more embodiments of the present disclosure.

FIG. 3A illustrates a top view of a first surface of a first configuration of a waveguide combiner of a near-eye display system according to embodiments of the present disclosure.

FIG. 3B illustrates a bottom view of a second surface of a first configuration of a waveguide combiner of a near-eye display system according to embodiments of the present disclosure.

FIG. 3C illustrates a K-Space diagram of a first configuration of a waveguide combiner according to embodiments of the present disclosure.

FIG. 3D illustrates a comparison of pupil replication graphs of a first configuration and a conventional grating vector architecture according to embodiments of the present disclosure.

FIG. 4A illustrates a top view of a first surface of a second configuration of a waveguide combiner of a near-eye display system according to embodiments of the present disclosure.

FIG. 4B illustrates a bottom view of a second surface of a second configuration of a waveguide combiner of a near-eye display system according to embodiments of the present disclosure.

FIG. 4C illustrates a K-Space diagram of a second configuration of a waveguide combiner according to embodiments of the present disclosure.

FIG. 5A illustrates a top view of a first surface of a third configuration of a waveguide combiner of a near-eye display system according to embodiments of the present disclosure.

FIG. 5B illustrates a bottom view of a second surface of a third configuration of a waveguide combiner of a near-eye display system according to embodiments of the present disclosure.

FIG. 5C illustrates a K-Space diagram of a third configuration of a fourth configuration according to embodiments of the present disclosure.

FIG. 5D illustrates a comparison of pupil replication graphs of a third configuration and a conventional grating vector architecture according to embodiments of the present disclosure.

FIG. 6A illustrates a top view of a first surface of a fourth configuration of a waveguide combiner of a near-eye display system according to embodiments of the present disclosure.

FIG. 6B illustrates a bottom view of a second surface of a fourth configuration of a waveguide combiner of a near-eye display system according to embodiments of the present disclosure.

FIG. 6C illustrates a K-Space diagram of a fourth configuration of a waveguide combiner according to embodiments of the present disclosure.

FIG. 6D illustrates a comparison of pupil replication graphs of a fourth configuration and a conventional grating vector architecture according to embodiments of the present disclosure.

FIG. 7A illustrates a top view of a first surface of a fifth configuration of a waveguide combiner of a near-eye display system according to embodiments of the present disclosure.

FIG. 7B illustrates a bottom view of a second surface of a fifth configuration of a waveguide combiner of a near-eye display system according to embodiments of the present disclosure.

FIG. 7C illustrates a K-Space diagram of a fifth configuration of a waveguide combiner according to embodiments of the present disclosure.

FIG. 8A illustrates a top view of a first surface of a sixth configuration of a waveguide combiner of a near-eye display system according to embodiments of the present disclosure.

FIG. 8B illustrates a bottom view of a second surface of a sixth configuration of a waveguide combiner of a near-eye display system according to embodiments of the present disclosure.

FIG. 8C illustrates a K-Space diagram of a sixth configuration of a waveguide combiner according to embodiments of the present disclosure.

FIG. 8D illustrates a comparison of pupil replication graphs of a sixth configuration and a conventional grating vector architecture according to embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to near-eye display systems. More specifically, embodiments described herein relate to near-eye display systems with an increased exit pupil density, image sharpness, and image uniformity. The diffractive waveguide combiner layer is designed to increase exit pupil density without substantially decreasing the thickness of the waveguide combiner layer. Since the thickness of the waveguide combiner layer is not substantially decreased, in-coupler rebounce is avoided. But since the exit pupil density is also high, high-frequency non-uniformities in the projected image are also avoided, particularly with the use of lasers.

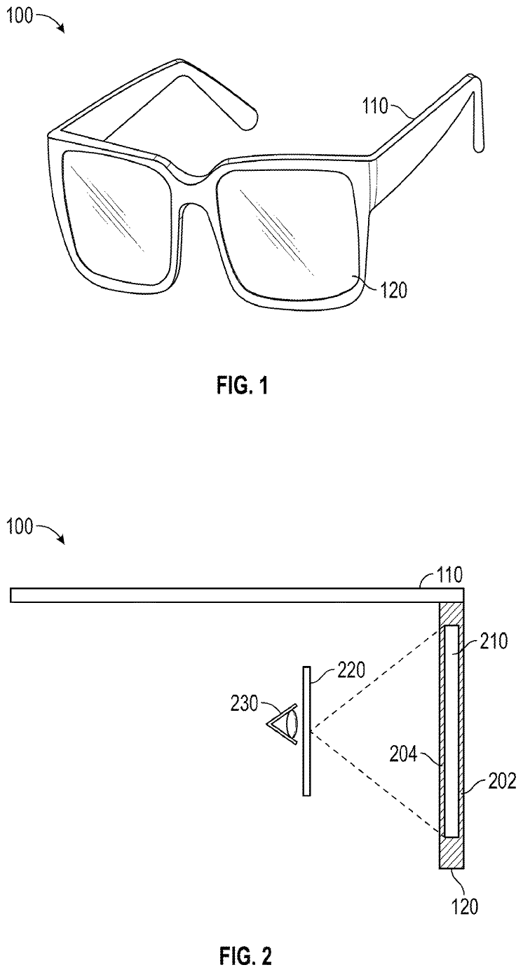

FIG. 1 illustrates a perspective view of a near-eye display system 100 according to one or more embodiments of the present disclosure. The near-eye display system 100 can present media to a user. Examples of media presented by the near-eye display system 100 can include one or more images, video, and/or audio. In one embodiment, which can be combined with other embodiments, audio may be presented via an external device (e.g., speakers and/or headphones) that receives audio information from the near-eye display system 100, a console, or both, and presents audio data based on the audio information. The near-eye display system 100 is generally configured to operate as an artificial reality display. In one embodiment, which can be combined with other embodiments, the near-eye display system 100 can operate as an augmented reality (AR) display.

The near-eye display system 100 can include a frame 110 and a display 120. The frame 110 can be coupled to one or more optical elements. The display 120 can be configured for the user to see content presented by the near-eye display system 100. In one embodiment, which can be combined with other embodiments, the display 120 can include a waveguide combiner for directing light from one or more images to an eye of the user.

FIG. 2 illustrates a cross-sectional view of the near-eye display system 100 of FIG. 1 according to one or more embodiments of the present disclosure. The near-eye display system 100 can include at least one waveguide combiner 210 having a first surface 202 opposing a second surface 204. The waveguide combiner 210 is configured to direct image light, for example display light, to an eyebox 220 defining an eyebox plane and then to a user's eye 230. The waveguide combiner 210 can include one or more materials with one or more refractive indices. In one embodiment, which can be combined with other embodiments, the near-eye display system 100 can include one or more optical elements between the waveguide combiner 210 and the user's eye 230.

Embodiments of the present disclosure discuss diffractive waveguide combiner layers with new grating architectures which utilize additional gratings. For example, dual fold gratings with unique grating vectors or dual replicator gratings with unique grating vectors may be utilized to enhance replication of the pupil prior to spreading and out-coupling of the pupil in subsequent grating regions, such as the out-coupler.

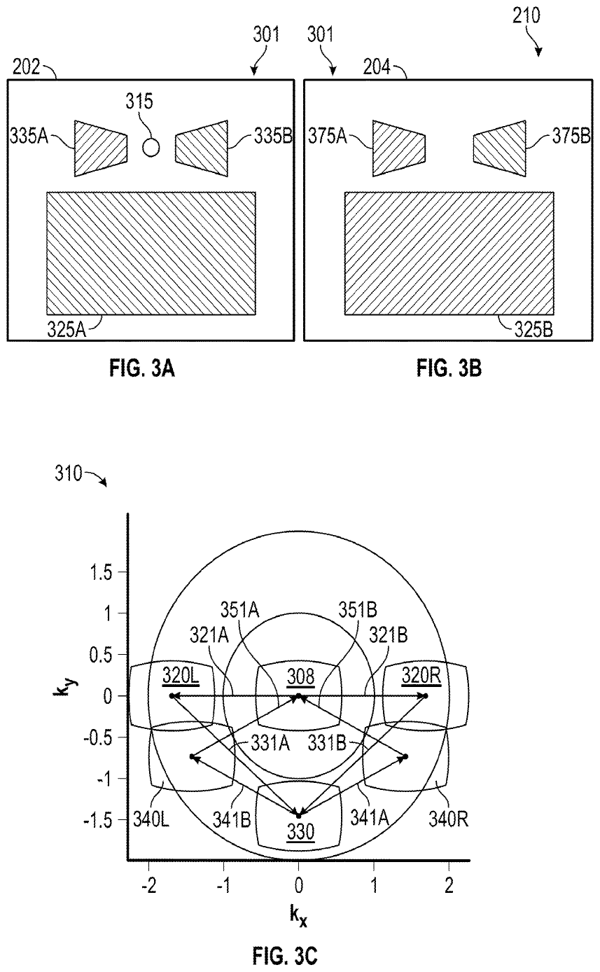

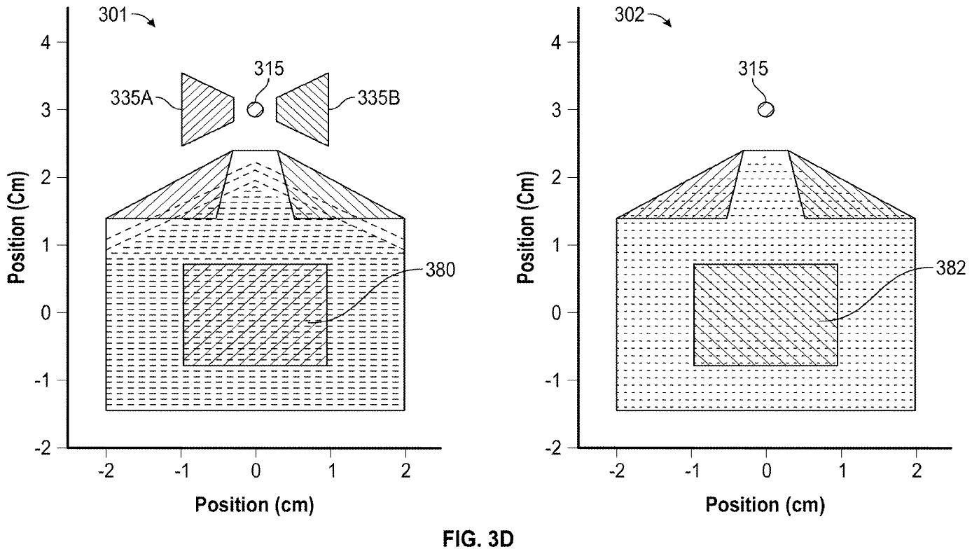

FIG. 3A illustrates a top view of a first surface 202 of a first configuration 301 of the waveguide combiner 210 of the near-eye display system 100 according to embodiments. FIG. 3B illustrates a bottom view of a second surface 204 of the first configuration 301 of the waveguide combiner 210 of the near-eye display system 100 according to embodiments. The second surface 204 is opposite of the first surface 202.

The first surface 202 of the first configuration 301 includes an in-coupler 315, a first fold grating 335A, a second fold grating 335B, and a first out-coupler 325A disposed thereon or thereover. The first fold grating 335A is located adjacent to the in-coupler 315. The second fold grating 335B is located adjacent to the in-coupler 315 opposite the first fold grating 335A. The first out-coupler 325A is located adjacent to the in-coupler 315, the first fold grating 335A, and the second fold grating 335B. In one example, the first out-coupler 325A is positioned above the first fold grating 335A and the second fold grating 335B. In another example, the first out-coupler 325A is positioned below the first fold grating 335A and the second fold grating 335B.

The second surface 204 of the first configuration 301 includes a second out-coupler 325B disposed thereon or thereover. In one embodiment, which can be combined with other embodiments described herein, the second surface 204 of the first configuration 301 includes the second out-coupler 325B, a third fold grating 375A, and a fourth fold grating 375B. The third fold grating 375A is adjacent to the fourth fold grating 375B. In one example of an embodiment including the third fold grating 375A and the fourth fold grating 375B, the second out-coupler 325B is positioned above the third fold grating 375A and the fourth fold grating 375B. In another example of an embodiment including the third fold grating 375A and the fourth fold grating 375B, the second out-coupler 325B is positioned below the third fold grating 375A and the fourth fold grating 375B. The in-coupler 315 may have a circular geometry or an ovular geometry. The first out-coupler 325A and the second out-coupler 325B may have a square geometry or a rectangular geometry. The first fold grating 335A and the second fold grating 335B may have a trapezoidal geometry.

FIG. 3C illustrates a K-Space diagram 310 of the first configuration 301 of the waveguide combiner 210. The K-Space diagram 310 depicts the path of a virtual FOV generated from a microdisplay of the near-eye display system 100. The path of the virtual FOV is the intended image path using a hexagonal lattice structure of K-Space regions. In a K-Space diagram the inner circle represents free space, the outer circle represents the substrate, and the space between the outer diameters of the circles represents TIR. In an optical device, the virtual FOV (light) propagates in TIR between gratings. As shown in the K-Space diagram 310, light from a light source, e.g., the virtual FOV, is in-coupled by the in-coupler 315 and diffracted as beams along a path 321A to a first region 320L corresponding to directions of light which will propagate to the first fold grating 335A and a path 321B to a second region 320R corresponding to directions of light which will propagate to the second fold grating 335B. L and R represent “Left” and “Right” respectively. The beams incident on the first fold grating 335A are diffracted along a path 331A to a region 330 corresponding to directions of light which will propagate to the first out-coupler 325A and the second out-coupler 325B. The beams incident on the second fold grating 335B are diffracted along the path 331B to the region 330 corresponding to directions of light which will propagate to the first out-coupler 325A and the second out-coupler 325B. The beams incident to the first out-coupler 325A are diffracted by the first out-coupler 325A along a path 341A to region 340R corresponding to directions of light which will propagate to the second out-coupler 325B. The second out-coupler 325B then out-couples the light along a path 351B to the user eyebox 308. The beams on the incident to the second out-coupler 325B are diffracted by the second out-coupler 325B along a path 341B to region 340L corresponding to directions of light which will propagate to the first out-coupler 325A. The first out-coupler 325A then out-couples the light along a path 351A to the user eyebox 308.

The locations of the first region 320L and the second region 320R must be different than the locations of the regions 340L and 340R, respectively, to ensure that the new grid of diffracted beam regions corresponding to regions 340L and 340R does not align with the current grid of diffracted beam regions corresponding to the first region 320L and the second region 320R. Additionally, the placement of the first fold grating 335A and the second fold grating 335B is mitigates instances of the new grid of diffracted beam regions creating an entirely new set of exit pupil regions which can reach the user eyebox and creating “ghost paths” which may result in secondary, shifted copies of the intended virtual content in the user's FOV. In some embodiments, the locations of the first region 320L and the second region 320R and the locations of regions 340L and 340R involves shifting the locations of regions 340L and 340R in K-Space such that the shifted region locations are far enough away from current K-Space region locations 320L and 320R (e.g., at least about 0.02 k₀ away, where k₀ is 2*pi/lambda and lambda is the wavelength of light).

FIG. 3D illustrates a comparison of pupil replication graphs of the first configuration 301 and a conventional grating vector architecture 302. The pupil replication graphs represent a FOV angle of about (0 degrees, 0 degrees). As shown in FIG. 3D, each of the points in the pupil replication graphs represent exit pupils. An eyebox 380 of the waveguide combiner 210 includes a greater number of exit pupils than an eyebox 382 of the conventional grating vector architecture 302. The eyebox 380 receiving a greater number of exit pupils results in an increased exit pupil density with a waveguide combiner having the same thickness. FIG. 3D allows for direct comparison of the enhanced pupil replication and increased exit pupil density with the waveguide combiner 210. The increase density of pupils with the waveguide combiner 210 is achieved with a substrate having the same thickness as a waveguide combiner with the conventional grating vector architecture 302. For example, the exit pupil density is at least about 5 times higher than the waveguide combiner with the conventional grating vector architecture 302. Thus, the thickness of the substrate does not need to be decreased or may even be increased while retaining a high exit pupil density. This mitigates the negative image effects of in-coupler rebounce while also limiting high-frequency non-uniformities.

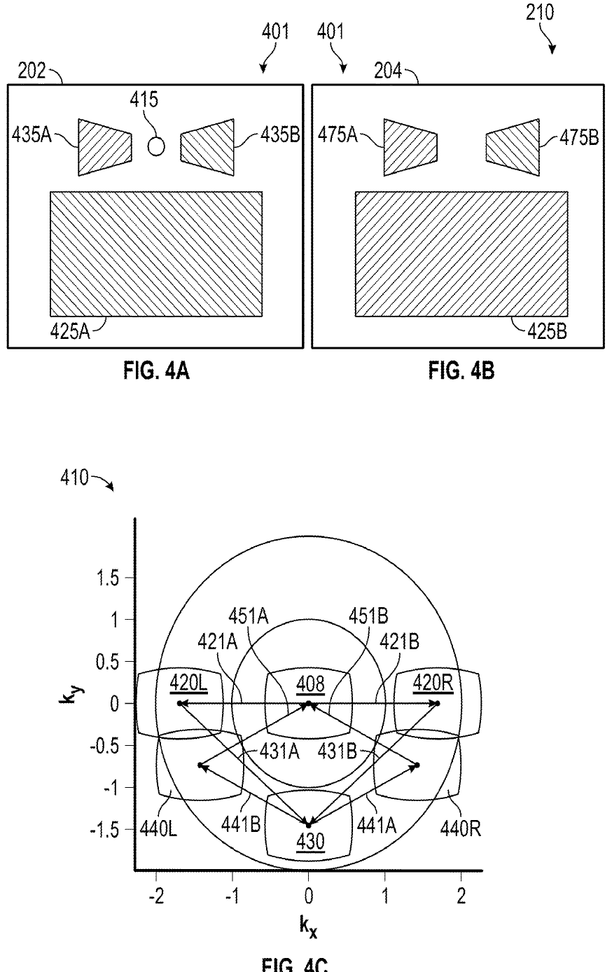

FIG. 4A illustrates a top view of a first surface 202 of a second configuration 401 of a waveguide combiner 210 of the near-eye display system 100 according to embodiments. FIG. 4B illustrates a bottom view of a second surface 204 of a waveguide combiner 210 of the near-eye display system 100 according to embodiments. The second surface 204 is opposite of the first surface 202.

The first surface 202 of the waveguide combiner 210 includes an in-coupler 415, a first two-dimensional out-coupler 425A, a first fold grating 435A and a second fold grating 435B disposed thereon or thereover. A two-dimensional grating, such as the first two-dimensional out-coupler 425A, contains periodicity in two directions resulting in diffraction orders in two directions. The first fold grating 435A is located adjacent to the in-coupler 415. The second fold grating 435B is located adjacent to the in-coupler 415 opposite the first fold grating 435A. The first two-dimensional out-coupler 425A is located adjacent to the in-coupler 415, the first fold grating 435A, and the second fold grating 435B. In one example, the first two-dimensional out-coupler 425A is positioned above the first fold grating 435A and the second fold grating 435B. In another example, the first two-dimensional out-coupler 425A is positioned below the first fold grating 435A and the second fold grating 435B.

In one embodiment, which can be combined with other embodiments described herein, the second surface 204 of the waveguide combiner 210 includes a third fold grating 475A, a fourth fold grating 475B, and a second out-coupler 425B. The second out-coupler 425B may be a one-dimensional or a two-dimensional out-coupler. The third fold grating 475A is adjacent to the fourth fold grating 475B. In one example of an embodiment including the third fold grating 475A and the fourth fold grating 475B, the second out-coupler 425B is positioned above the third fold grating 475A and the fourth fold grating 475B. In another example of an embodiment including the third fold grating 475A and the fourth fold grating 475B, the second out-coupler 425B is positioned below the third fold grating 475A and the fourth fold grating 475B. The in-coupler 415 may have a circular geometry or an ovular geometry. The first two-dimensional out-coupler 425A may have a rectangular geometry or a square geometry. The first fold grating 435A and the second fold grating 435B may have a trapezoidal geometry.

FIG. 4C illustrates a K-Space diagram 410 of the second configuration 401 of the waveguide combiner 210. FIG. 4C is similar to FIG. 3C, except the out-coupler 425A is a two-dimensional out-coupler. The K-Space diagram 410 depicts the path of a virtual FOV generated from a microdisplay of the near-eye display system 100. The path of the virtual FOV is the intended image path using a hexagonal lattice structure of K-Space regions. As shown in the K-Space diagram 410, light from a light source, e.g., the virtual FOV, is in-coupled by the in-coupler 415 and diffracted as beams along a path 421A to a first region 420L corresponding to directions of light which will propagate to the first fold grating 435A and a path 421B to a second region 420R corresponding to directions of light which will propagate to the second fold grating 435B. L and R represent “Left” and “Right” respectively. The beams incident on the first fold grating 435A are diffracted along a path 431A to a region 430 corresponding to directions of light which will propagate to the first two-dimensional out-coupler 425A. The beams incident on the second fold grating 435B are diffracted along the path 431B to the region 430 corresponding to directions of light which will propagate to the first two-dimensional out-coupler 425A. The beams incident to the first two-dimensional out-coupler 425A are diffracted in two-directions along a path 441A to a region 440R and along a path 441B to a region 440L. The first two-dimensional out-coupler 425A then out-couples the light from region 440L along path 451A and from region 440R along path 451B to the user eyebox 408.

The locations of the first region 420L and the second region 420R must be different than the locations of the regions 440L and 440R, respectively, to ensure that the new grid of diffracted beam regions corresponding to regions 440L and 440R does not align with the current grid of diffracted beam regions corresponding to the first region 420L and the second region 420R. Additionally, the placement of the first fold grating 435A and the second fold grating 435B mitigate occurrences of the new grid of diffracted beam regions creating an entirely new set of exit pupil regions which can reach the user eyebox and create “ghost paths” which may result in secondary, shifted copies of the intended virtual content in the user's FOV. In some embodiments, the locations of the first region 420L and the second region 420R and the locations of regions 440L and 440R involves shifting the locations of regions 440L and 440R in K-Space such that the shifted region locations are far enough away from current K-Space region locations 420L and 420R (e.g., at least about 0.02 k₀ away).

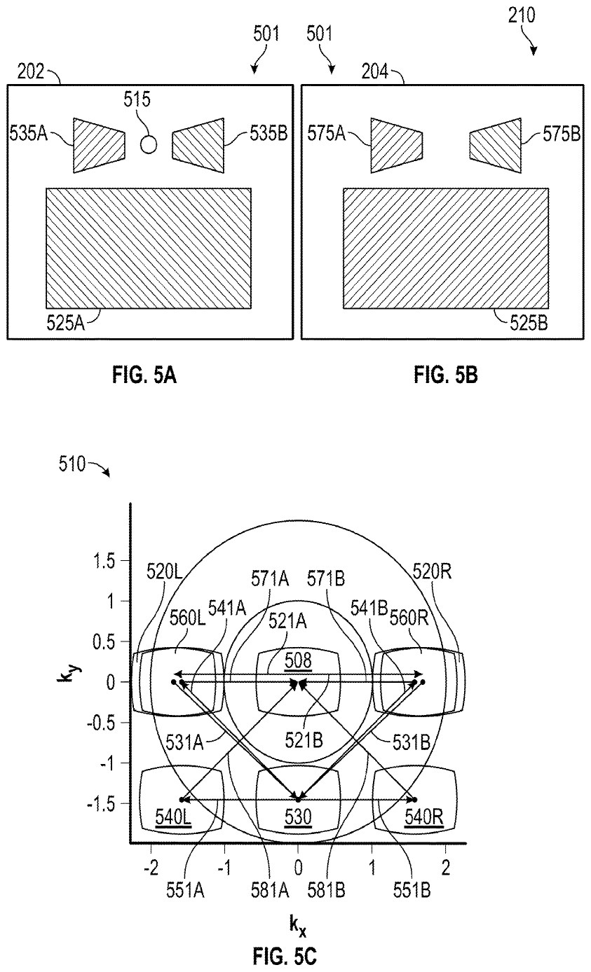

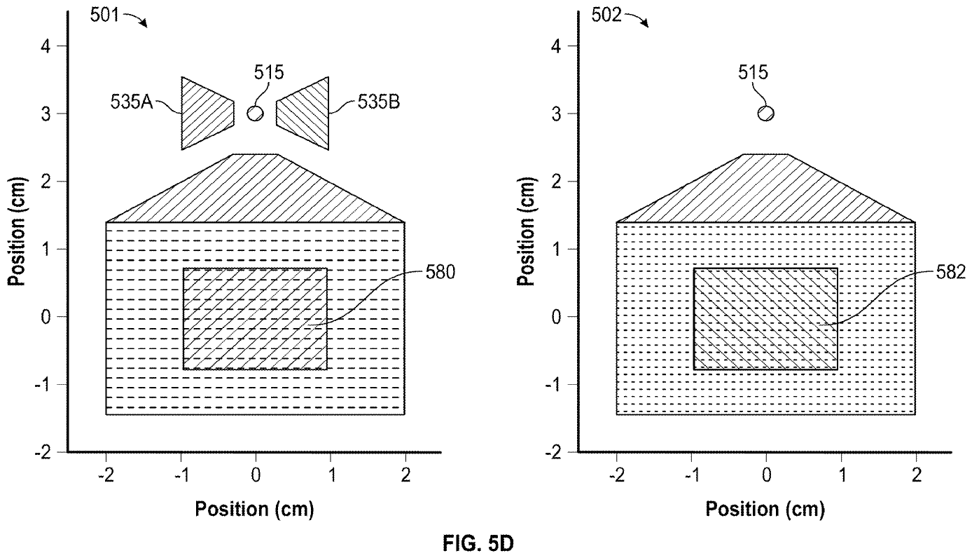

FIG. 5A illustrates a top view of a first surface 202 of a third configuration 501 waveguide combiner 210 of the near-eye display system 100 according to embodiments. FIG. 5B illustrates a bottom view of a second surface 204 of the waveguide combiner 210 of the near-eye display system 100 according to embodiments. The second surface 204 is opposite of the first surface 202.

The first surface 202 of the waveguide combiner 210 includes an in-coupler 515, a first out-coupler 525A, a first fold grating 535A, and a second fold grating 535B. The first fold grating 535A is located adjacent to the in-coupler 515. The second fold grating 535B is located adjacent to the in-coupler 515 opposite the first fold grating 535A. The first out-coupler 525A is located adjacent to the in-coupler 515, the first fold grating 535A, and the second fold grating 535B. In one example, the first out-coupler 525A is positioned above the first fold grating 435A and the second fold grating 435B. In another example, the first out-coupler 525A is positioned below the first fold grating 435A and the second fold grating 435B.

The second surface 204 of the waveguide combiner 210 includes a two-dimensional expander grating 525B. In one embodiment, which can be combined with other embodiments described herein, the second surface 204 of the waveguide combiner 210 includes the two-dimensional expander grating 525B, a third fold grating 575A, and a fourth fold grating 575B. The third fold grating 575A is adjacent to the fourth fold grating 575B. In one example of an embodiment including the third fold grating 575A and the fourth fold grating 575B, the two-dimensional expander grating 525B is positioned above the third fold grating 575A and the fourth fold grating 575B. In another example of an embodiment including the third fold grating 575A and the fourth fold grating 575B, the two-dimensional expander grating 525B is positioned below the third fold grating 575A and the fourth fold grating 575B. The in-coupler 515 may have a circular geometry or an ovular geometry. The first out-coupler 525A and the two-dimensional expander grating 525B may have a square geometry or a rectangular geometry. The first fold grating 535A and the second fold grating 535B may have a trapezoidal geometry.

FIG. 5C illustrates a K-Space diagram 510 of the third configuration 501 of the waveguide combiner 210. K-Space diagram 510 depicts the path of a virtual FOV generated from a microdisplay of the near-eye display system 100. The path of the virtual FOV is the intended image path using a rectangular lattice structure of K-Space regions. As shown in the K-Space diagram 510, light from a light source, e.g., the virtual FOV, is in-coupled by the in-coupler 515 and diffracted as beams along a path 521A to a first region 520L corresponding to directions of light which will propagate to the first fold grating 535A and a path 521B to a second region 520R corresponding to directions of light which will propagate to the second fold grating 535B. L and R represent “Left” and “Right” respectively. The beams incident on the first fold grating 535A are diffracted along a path 531A to a region 530 corresponding to directions of light which will propagate to the first out-coupler 525A and the two-dimensional expander grating 525B. The beams incident on the second fold grating 535B are diffracted along a path 531B to the region 530 corresponding to directions of light which will propagate to the first out-coupler 525A and the two-dimensional expander grating 525B. The beams incident to the first out-coupler 525A are diffracted by the first out-coupler 525A along a path 551A to a region 540L corresponding to directions of light which will propagate to the two-dimensional expander grating 525B and along a path 551B to a region 540R corresponding to directions of light which will propagate to the two-dimensional expander grating 525B. The two-dimensional expander grating 525B then out-couples the light along paths 581A and 581B to the user eyebox 508. The beams incident to the two-dimensional expander grating 525B are diffracted by the two-dimensional expander grating along a path 541A to a region 560L corresponding to directions of light which will propagate to the first out-coupler 525A and along a path 541B to a region 560R corresponding to directions of light which will propagate to the first out-coupler 525A. The first out-coupler 525A then out-couples the light along paths 571A and 571B to the user eyebox 508.

The locations of the first region 520L and the second region 520R must be different than the locations of the regions 560L and 560R, respectively, to ensure that the new grid of diffracted beam regions corresponding to regions 560L and 560R does not align with the current grid of diffracted beam regions corresponding to the first region 520L and the second region 520R. Additionally, the placement of the first fold grating 535A and the second fold grating 535B mitigate occurrences of the new grid of diffracted beam regions creating an entirely new set of exit pupil regions which can reach the user eyebox and create “ghost paths” which may result in secondary, shifted copies of the intended virtual content in the user's FOV. In some embodiments, the locations of the first region 520L and the second region 520R and the locations of regions 560L and 560R involves shifting the locations of regions 560L and 560R in K-Space such that the shifted region locations are far enough away from current K-Space region locations 520L and 520R (e.g., at least about 0.02 k₀ away).

FIG. 5D illustrates a comparison of pupil replication graphs of the third configuration 501 and a conventional grating vector architecture 502. The pupil replication graphs represent a FOV angle of about (0 degrees, 0 degrees). As shown in FIG. 5D, each of the points in the pupil replication graphs represent exit pupils. An eyebox 580 of the waveguide combiner 210 includes a greater number of exit pupils than an eyebox 582 of the conventional grating vector architecture 502. The eyebox 580 receiving a greater number of exit pupils results in an increased exit pupil density with a waveguide combiner having the same thickness. FIG. 5D allows for direct comparison of the enhanced pupil replication and increased exit pupil density with the waveguide combiner 210. The increase density of pupils with the waveguide combiner 210 is achieved with a substrate having the same thickness as a waveguide combiner with the conventional grating vector architecture 502. For example, the exit pupil density is at least about 5 times higher than the waveguide combiner with the conventional grating vector architecture 502. Thus, the thickness of the substrate does not need to be decreased or may even be increased while retaining a high exit pupil density. This mitigates the negative image effects of in-coupler rebounce while also limiting high-frequency non-uniformities.

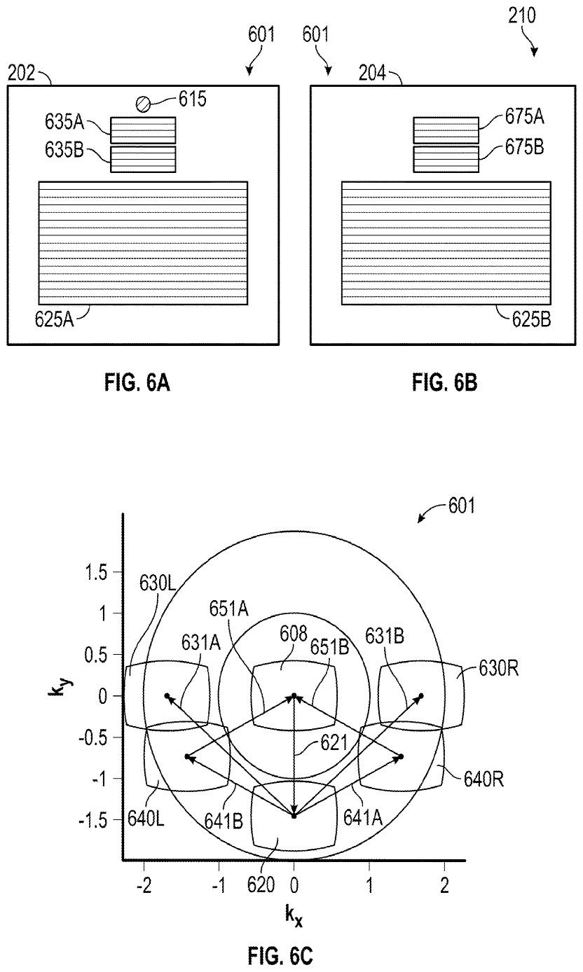

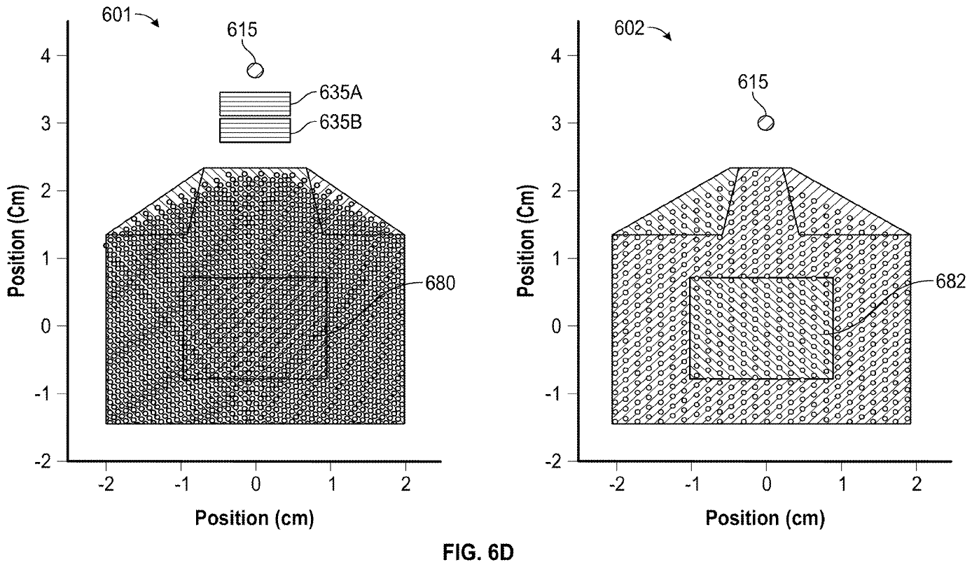

FIG. 6A illustrates a top view of a first surface 202 of a fourth configuration 601 of a waveguide combiner 210 of the near-eye display system 100 according to embodiments. FIG. 6B illustrates a bottom view of a second surface 204 of the waveguide combiner 210 of the near-eye display system 100 according to embodiments. The second surface 204 is opposite of the first surface 202.

The first surface 202 of the waveguide combiner 210 includes an in-coupler 615, a first replicator grating 635A, a second replicator grating 635B, and a first out-coupler 625A disposed thereon or thereover. The first replicator grating 635A is located adjacent to or below the in-coupler 615 from a top view, as shown in FIG. 6A. The second replicator grating 635B is located adjacent to or below the first replicator grating 635A from a top view, as shown in FIG. 6A, such that the first replicator grating 635A and the second replicator grating 635B are in series. In one example, the first out-coupler 625A is located adjacent to or below the second replicator grating 635B from a top view, as shown in FIG. 6A. In another example, the first out-coupler 625A is positioned above the in-coupler 615.

The second surface 204 of the waveguide combiner 210 includes a second out-coupler 625B disposed thereon or thereover. In one embodiment, which can be combined with other embodiments described herein, the second surface 204 of the waveguide combiner 210 includes the second out-coupler 625B, a third replicator grating 675A, and a fourth replicator grating 675B. The fourth replicator grating 675B is adjacent to or below the third replicator grating 675A. In one example of an embodiment including the third replicator grating 675A and the fourth replicator grating 675B, the second out-coupler 625B is positioned above the third replicator grating 675A. In another example of an embodiment including the third replicator grating 675A and the fourth replicator grating 675B, the second out-coupler 625B is positioned below the fourth replicator grating 675B. The in-coupler 615 may have a circular geometry or an ovular geometry. The first out-coupler 625A and the second out-coupler 625B may have a square geometry or a rectangular geometry. The first replicator grating 635A and the second replicator grating 635B may have a square or rectangular geometry.

FIG. 6C illustrates a K-Space diagram of the fourth configuration 601 of the waveguide combiner 210. The K-Space diagram depicts the path of a virtual FOV generated from a microdisplay of the near-eye display system 100. The path of the virtual FOV is the intended image path using a hexagonal lattice structure of K-Space regions. As shown in the K-Space diagram, light from a light source, e.g., the virtual FOV, is in-coupled by the in-coupler 615 and diffracted as beams along a path 621 to a first region 620. The beams incident on the first replicator grating 635A are diffracted along a path 631A to a region 630L corresponding to directions of light which will propagate to the first replicator grating 635A where the beams re-encounter the first replicator grating 635A and are diffracted back to the first region 620. The beams diffracted back to the first region 620 encounter the second replicator grating 635B and are diffracted along a path 631B to a region 630R corresponding to directions of light which will propagate to the second replicator grating 635B where the beams are diffracted back to the first region 620. L and R represent “Left” and “Right” respectively. The beams diffracted back to the first region 620 by the second replicator grating 635B that are incident to the first out-coupler 625A are diffracted by the first out-coupler 625A along a path 641A to region 640R corresponding to directions of light which will propagate to the second out-coupler 625B. The second out-coupler 625B then out-couples the light along a path 651B to the user eyebox 608. The beams diffracted back to the first region 620 by the second replicator grating 635B that are incident to the second out-coupler 625B are diffracted by the second out-coupler 625B along a path 641B to region 640L corresponding to directions of light which will propagate to the first out-coupler 625A. The first out-coupler 625A then out-couples the light along a path 651A to the user eyebox 608.

The locations of the region 630L and the region 630R must be different than the locations of the regions 640L and 640R, respectively, to ensure that the new grid of diffracted beam regions corresponding to regions 640L and 640R does not align with the current grid of diffracted beam regions corresponding to the region 630L and the region 630R. Additionally, the placement of the first replicator grating 635A and the second replicator grating 635B is mitigates the occurrence of diffracted beam regions creating an entirely new set of exit pupil regions which can reach the user eyebox and create “ghost paths” which may result in secondary, shifted copies of the intended virtual content in the user's FOV. In some embodiments, the locations of the region 630L and the region 630R and the locations of regions 640L and 640R involves shifting the locations of regions 640L and 640R in K-Space such that the shifted region locations are far enough away from current K-Space region locations 630L and 630R (e.g., at least about 0.02 k₀ away).

FIG. 6D illustrates a comparison of pupil replication graphs of the fourth configuration 601 and a conventional grating vector architecture 602. The pupil replication graphs represent a FOV angle of about (0 degrees, 0 degrees). As shown in FIG. 6D, each of the points in the pupil replication graphs represent exit pupils. An eyebox 680 of the waveguide combiner 210 includes a greater number of exit pupils than an eyebox 682 of the conventional grating vector architecture 602. The eyebox 680 receiving a greater number of exit pupils results in an increased exit pupil density with a waveguide combiner having the same thickness. FIG. 6D allows for direct comparison of the enhanced pupil replication and increased exit pupil density with the waveguide combiner 210. The increase density of pupils with the waveguide combiner 210 is achieved with a substrate having the same thickness as a waveguide combiner with the conventional grating vector architecture 602. For example, the exit pupil density is at least about 5 times higher than the waveguide combiner with the conventional grating vector architecture 602. Thus, the thickness of the substrate does not need to be decreased or may even be increased while retaining a high exit pupil density. This mitigates the negative image effects of in-coupler rebounce while also limiting high-frequency non-uniformities.

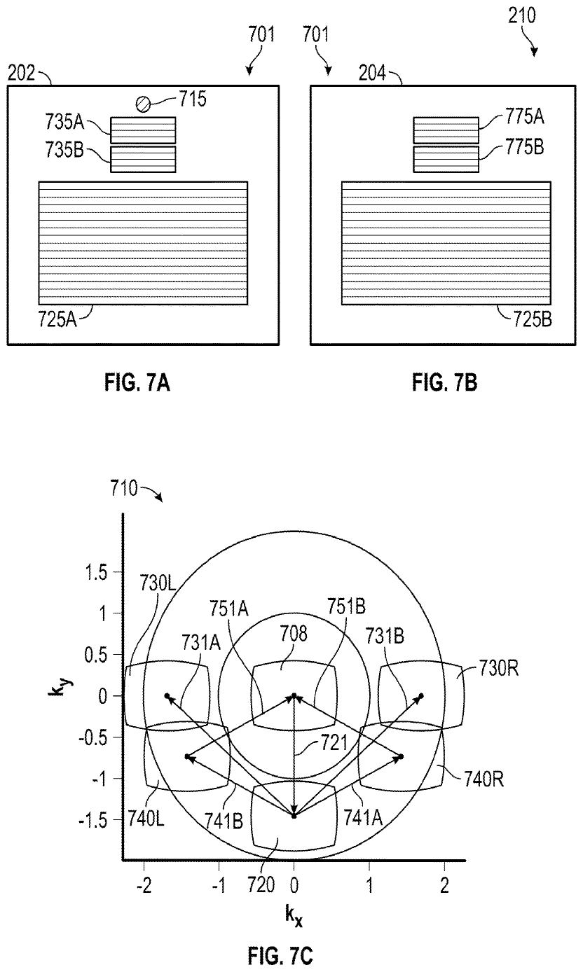

FIG. 7A illustrates a top view of a first surface 202 of a fifth configuration 701 of a waveguide combiner 210 of the near-eye display system 100 according to embodiments. FIG. 7B illustrates bottom view of a second surface 204 of the fifth configuration 701 and the waveguide combiner 210 of the near-eye display system 100 according to embodiments. The second surface 204 is opposite of the first surface 202.

The first surface 202 of the waveguide combiner 210 includes an in-coupler 715, a first two-dimensional out-coupler 725A, a first replicator grating 735A and a second replicator grating 735B disposed thereon or thereover. A two-dimensional grating, such as the first two-dimensional out-coupler 725A, contains periodicity in two directions resulting in diffraction orders in two directions. The first replicator grating 735A is located adjacent to or below the in-coupler 715 from a top view, as shown in FIG. 7A. The second replicator grating 735B is located adjacent to or below the first replicator grating 735A from a top view, as shown in FIG. 7A, such that the first replicator grating 735A and the second replicator grating 735B are in series. In one example, the first two-dimensional out-coupler 725A is located adjacent to or below the second replicator grating 735B from a top view, as shown in FIG. 7A. In another example, the first two-dimensional out-coupler 725A is positioned above the in-coupler 715.

In one embodiment, which can be combined with other embodiments described herein, the second surface 204 of the waveguide combiner 210 includes a third replicator grating 775A, a fourth replicator grating 775B, and a second out-coupler 725B. The second out-coupler 725B may be a one-dimensional or a two-dimensional out-coupler. The fourth replicator grating 775B is adjacent to or below the third replicator grating 775A. In one example of an embodiment including the third replicator grating 775A and the fourth replicator grating 775B, the second out-coupler 725B is positioned above the third replicator grating 775A. In another example of an embodiment including the third replicator grating 775A and the fourth replicator grating 775B, the second out-coupler 725B is positioned below the fourth replicator grating 775B. The in-coupler 715 may have a circular geometry or an ovular geometry. The first two-dimensional out-coupler 725A may have a square geometry or a rectangular geometry. The first fold grating 735A and the second fold grating 735B may have a trapezoidal geometry.

FIG. 7C illustrates a K-Space diagram 710 of the fifth configuration 701 of the waveguide combiner 210. FIG. 7C is similar to FIG. 6C, except the out-coupler 725A is a two-dimensional out-coupler. As shown in the K-Space diagram 710, light from a light source, e.g., the virtual FOV, is in-coupled by the in-coupler 715 and diffracted as beams along a path 721 to a first region 720. The beams incident on the first replicator grating 735A are diffracted along a path 731A to a region 730L corresponding to directions of light which will propagate to the first replicator grating 735A where the beams re-encounter the first replicator grating 735A and are diffracted back to the first region 720. The beams diffracted back to the first region 720 by the first replicator grating 735A encounter the second replicator grating 735B and are diffracted along a path 731B to a region 730R corresponding to directions of light which will propagate to the second replicator grating 735B where the beams are diffracted back to the first region 720. L and R represent “Left” and “Right” respectively. The beams diffracted back to the first region 720 by the second replicator grating 735B that are incident to the first two-dimensional out-coupler 725A are diffracted by the first two-dimensional out-coupler 725A along paths 741A and 741B to regions 740R and 740L, respectively. The first two-dimensional out-coupler 725A then out-couples the light along paths 751A and 751B to the user eyebox 708.

The locations of the region 730L and the region 730R must be different than the locations of the regions 740L and 740R, respectively, to ensure that the new grid of diffracted beam regions corresponding to regions 740L and 740R does not align with the current grid of diffracted beam regions corresponding to the region 730L and the region 730R. Additionally, the placement of the first replicator grating 735A and the second replicator grating 735B reduce the occurrence of diffracted beam regions creating an entirely new set of exit pupil regions which can reach the user eyebox and create “ghost paths” which may result in secondary, shifted copies of the intended virtual content in the user's FOV. In some embodiments, the locations of the region 730L and the region 730R and the locations of regions 740L and 740R involves shifting the locations of regions 740L and 740R in K-Space such that the shifted region locations are far enough away from current K-Space region locations 730L and 730R (e.g., at least about 0.02 k₀ away).

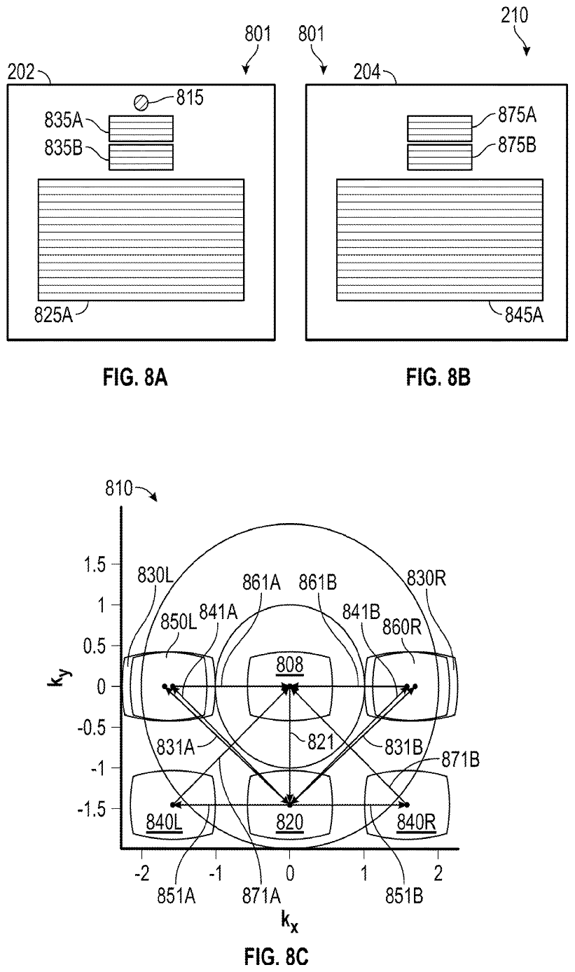

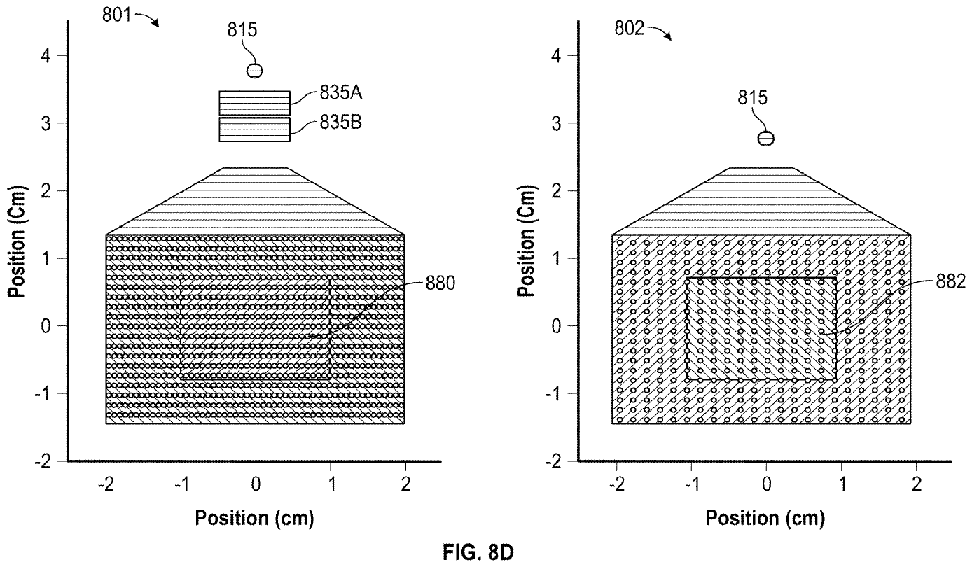

FIG. 8A illustrates a top view of a first surface 202 of a waveguide combiner 801 of a waveguide combiner 801 of the near-eye display system 100 according to embodiments. FIG. 8B illustrates a bottom view of a second surface 204 of the waveguide combiner 801 of the waveguide combiner 801 of the near-eye display system 100 according to embodiments. The second surface 204 is opposite of the first surface 202.

The first surface 202 of the waveguide combiner 801 includes an in-coupler 815, a first out-coupler 825A, a first replicator grating 835A, and a second replicator grating 835B. The first replicator grating 835A is located adjacent to or below the in-coupler 815 from a top view, as shown in FIG. 8A. The second replicator grating 835B is located adjacent to or below the first replicator grating 835A from a top view, as shown in FIG. 8A, such that the first replicator grating 835A and the second replicator grating 835B are in series. In one example, the first out-coupler 825A is located adjacent to or below the second replicator grating 835B from a top view, as shown in FIG. 8A. In another example, the first out-coupler 825A is positioned above the in-coupler 815.

The second surface 204 of the waveguide combiner 801 includes a two-dimensional expander grating 845A. In one embodiment, which can be combined with other embodiments described herein, the second surface 204 of the waveguide combiner 801 includes the two-dimensional expander grating 845A, a third replicator grating 875A, and a fourth replicator grating 875B. The fourth replicator grating 875B is adjacent to or below the third replicator grating 875A. In one example of an embodiment including the third replicator grating 875A and the fourth replicator grating 875B, the two-dimensional expander grating 845A is positioned above the third replicator grating 875A. In another example of an embodiment including the third replicator grating 875A and the fourth replicator grating 875B, the two-dimensional expander grating 845A is positioned below the fourth replicator grating 875B. The in-coupler 815 may have a circular geometry or an ovular geometry. The first out-coupler 825A and the two-dimensional expander grating 845A may have a square or rectangular geometry. The first replicator grating 835A and the second replicator grating 835B may have a square or rectangular geometry.

FIG. 8C illustrates a K-Space diagram 810 of the waveguide combiner 801 of the waveguide combiner 801. K-Space diagram 810 depicts the path of a virtual FOV generated from a microdisplay of the near-eye display system 100. The path of the virtual FOV is the intended image path using a rectangular lattice structure of K-Space regions. As shown in the K-Space diagram 810, light from a light source, e.g., the virtual FOV, is in-coupled by the in-coupler 815 and diffracted as beams along a path 821 to a first region 820. The beams incident on the first replicator grating 835A are diffracted along a path 831A to a region 830L corresponding to directions of light which will propagate to the first replicator grating 835A where the beams re-encounter the first replicator grating 835A and are diffracted back to the first region 820. The beams diffracted back to the first region 820 by the first replicator grating 835A incident on the second replicator grating 835B are diffracted along a path 831B to a region 830R corresponding to directions of light which will propagate to the second replicator grating 835B where the beams re-encounter the second replicator grating 835B and are diffracted back to the first region 820. L and R represent “Left” and “Right” respectively. The beams incident to the first out-coupler 825A are diffracted by the first out-coupler 825A along a path 851A to a region 840L corresponding to directions of light which will propagate to the two-dimensional expander grating 845A and along a path 851B to a region 840R corresponding to directions of light which will propagate to the two-dimensional expander grating 845A. The two-dimensional expander grating 845A then out-couples the light along paths 871A and 871B to the user eyebox 808. The beams incident to the two-dimensional expander grating 845A are diffracted by the two-dimensional expander grating along a path 841A to a region 850L corresponding to directions of light which will propagate to the first out-coupler 825A and along a path 841B to a region 860R corresponding to directions of light which will propagate to the first out-coupler 825A. The first out-coupler 825A then out-couples the light along paths 861A and 861B to the user eyebox 808.

The locations of the region 830L and the region 830R must be different than the locations of the regions 850L and 860R, respectively, to ensure that the new grid of diffracted beam regions corresponding to regions 850L and 860R does not align with the current grid of diffracted beam regions corresponding to the region 830L and the region 830R. Additionally, the placement of the first replicator grating 835A and the second replicator grating 835B reduce the occurrence of diffracted beam regions creating an entirely new set of exit pupil regions which can reach the user eyebox and create “ghost paths” which may result in secondary, shifted copies of the intended virtual content in the user's FOV. In some embodiments, the locations of the region 830L and the region 830R and the locations of regions 850L and 860R involves shifting the locations of regions 850L and 860R in K-Space such that the shifted region locations are far enough away from current K-Space region locations 830L and 830R (e.g., at least about 0.02 k₀ away).

FIG. 8D illustrates a comparison of pupil replication graphs of the waveguide combiner 801 and a conventional grating vector architecture 802. The pupil replication graphs represent a FOV angle of about (0 degrees, 0 degrees). As shown in FIG. 8D, each of the points in the pupil replication graphs represent exit pupils. An eyebox 880 of the waveguide combiner 801 includes a greater number of exit pupils than an eyebox 882 of the conventional grating vector architecture 802. The eyebox 880 receiving a greater number of exit pupils results in an increased exit pupil density with a waveguide combiner having the same thickness. FIG. 8D allows for direct comparison of the enhanced pupil replication and increased exit pupil density with the waveguide combiner 801. The increase density of pupils with the waveguide combiner 801 is achieved with a substrate having the same thickness as a waveguide combiner with the conventional grating vector architecture 802. For example, the exit pupil density is at least about 5 times higher than the waveguide combiner with the conventional grating vector architecture 802. Thus, the thickness of the substrate does not need to be decreased or may even be increased while retaining a high exit pupil density. This mitigates the negative image effects of in-coupler rebounce while also limiting high-frequency non-uniformities.

Each grating vector architecture of each waveguide combiner herein can be implemented in an actual waveguide combiner. For example, some potential variations include changing which surface of a waveguide combiner each grating is located on, changing the geometric boundary shape of the grating regions, modifying the grating vector magnitudes, and/or using any number of layers of waveguide combiners in a stack. In some embodiments, in single waveguide combiner layers, three display channels (red, green, blue) propagate through the same layer and diffract from the same grating structures to send the virtual image to the user's eye. In other embodiments, in three waveguide-layer systems, each waveguide combiner layer can be designed to support only a single display color channel. The further addition of gratings, the grating angle of all gratings, and the pitch of all gratings may be adjusted to achieve a particular set of optical characteristics.

Embodiments of near-eye display systems, as described herein, allow for increased exit pupil density, image sharpness, and image uniformity through the inclusion of additional fold gratings. The additional fold gratings and replicator gratings on the diffractive waveguide combiner layer are designed to increase the exit pupil density without substantially decreasing the thickness of the waveguide combiner layer. A waveguide combiner layer without a decreased thickness will experience the benefit of a decrease in in-coupler rebounce. Similarly, embodiments of near-eye display systems with additional fold gratings, as described herein, allow for the achieved benefit of decreased high-frequency non-uniformities in the projected image, particularly with the use of lasers. Decreasing high-frequency non-uniformities in the projected image, in turn, increases the image sharpness and image uniformity.

While the foregoing is directed to embodiments of the present disclosure, other and further implementations of the disclosure may be devised without departing from the basic scope thereof, and the scope thereof is determined by the claims that follow.

1. A waveguide combiner, comprising:
a first surface;
a second surface;
an in-coupler located on the first surface and configured to receive a plurality of input beams and diffract a first subset of beams and a second subset of beams into total-internal-reflection (TIR) in two opposite directions in K-Space;
a first fold grating located on the first surface and configured to receive the first subset of beams from the in-coupler at a first region in K-Space and diffract the first subset of beams in TIR to a second region in K-Space;
a second fold grating located on the first surface and configured to receive the second subset of beams from the in-coupler at a third region in K-Space and diffract the second subset of beams in TIR to the second region in K-Space; and
a first out-coupler located on the first surface.

2. The waveguide combiner of claim 1, wherein the first out-coupler is configured to receive the first subset of beams from the first fold grating and the second subset of beams from the second fold grating at the second region in K-Space, diffract a first portion of the first subset of beams and of the second subset of beams to a fourth region in K-Space, and out-couple a second portion of the first subset of beams and of the second subset of beams.

3. The waveguide combiner of claim 2, wherein the first out-coupler is a two-dimensional out-coupler.

4. The waveguide combiner of claim 2, further comprising a second out-coupler located on the second surface and configured to receive the first subset of beams from the first fold grating and the second subset of beams from the second fold grating at the second region in K-Space, diffract the second portion of the first subset of beams and the second subset of beams to a fifth region in K-Space, and out-couple the first portion of the first subset of beams and the second subset of beams.

5. The waveguide combiner of claim 4, further comprising a third fold grating located on the second surface.

6. The waveguide combiner of claim 5, further comprising a fourth fold grating located on the second surface.

7. The waveguide combiner of claim 6, wherein the fourth fold grating is located adjacent to the third fold grating and both the third fold grating and the fourth fold grating are located adjacent to the second out-coupler.

8. A waveguide combiner, comprising:
a first surface;
a second surface;
an in-coupler located on the first surface and configured to receive a plurality of input beams and diffract the plurality of input beams into total-internal-reflection (TIR);
a first replicator grating located adjacent to and below the in-coupler on the first surface and configured to receive the plurality of input beams from the in-coupler at a first region in K-Space and diffract the plurality of input beams in TIR to a second region in K-Space;
a second replicator grating located adjacent to and below the first replicator grating on the first surface;
a first out-coupler located adjacent to or below the second replicator grating on the first surface; and
a second out-coupler located on the second surface.

9. The waveguide combiner of claim 8, wherein the first replicator grating and the second replicator grating are square or rectangular shaped.

10. The waveguide combiner of claim 8, wherein the first out-coupler or the second out-coupler is a two-dimensional out-coupler.

11. The waveguide combiner of claim 8, further comprising a third replicator grating located on the second surface.

12. The waveguide combiner of claim 11, further comprising a fourth replicator grating located on the second surface.

13. The waveguide combiner of claim 12, where in the fourth replicator is located adjacent to and below the third replicator grating and the second out-coupler is located adjacent to and below the fourth replicator grating.

14. A waveguide combiner, comprising:
a first surface;
a second surface;
an in-coupler located on the first surface and configured to receive a plurality of input beams and diffract a first subset of beams and a second subset of beams into total-internal-reflection (TIR) in two opposite directions in K-Space;
a first fold grating located on the first surface and configured to receive the first subset of beams from the in-coupler at a first region in K-Space and diffract the first subset of beams in TIR to a second region in K-Space;
a second fold grating located on the first surface and configured to receive the second subset of beams from the in-coupler at a third region in K-Space and diffract the second subset of beams in TIR to the second region in K-Space;
an out-coupler located on the first surface and configured to receive the first subset of beams from the first fold grating and the second subset of beams from the second fold grating at the second region in K-Space, diffract a first portion of the first subset of beams and the second subset of beams to a fourth region in K-Space, diffract a second portion of the first subset of beams and the second subset of beams to a fifth region in K-Space, out-couple a third portion of the first subset of beams and the second subset of beams from a sixth region, and out-couple a fourth portion of the first subset of beams and the second subset of beams from a seventh region in K-Space; and
an expander grating located on the second surface and configured to receive the first portion of the first subset of beams and the second subset of beams from the first fold grating and the second fold grating at the second region in K-Space, diffract a third portion of the first subset of beams and the second subset of beams to the sixth region, diffract a fourth portion of the first subset of beams and the second subset of beams to the seventh region in K-Space, out-couple the first portion of the first subset of beams and the second subset of beams from the fourth region, and out-couple the second portion of the first subset of beams and the second subset of beams from the fifth region in K-Space.

15. The waveguide combiner of claim 14, wherein the in-coupler is circular or ovular shaped.

16. The waveguide combiner of claim 14, wherein the first fold grating and the second fold grating are trapezoidal shaped.

17. The waveguide combiner of claim 14, wherein the out-coupler and the expander grating are square or rectangular shaped.

18. The waveguide combiner of claim 14, further comprising a third fold grating located on the second surface.

19. The waveguide combiner of claim 18, further comprising a fourth fold grating located on the second surface.

20. The waveguide combiner of claim 19, wherein the fourth fold grating is located adjacent to the third fold grating and both the third fold grating and the fourth fold grating are located adjacent to the expander grating.

21. The waveguide combiner of claim 1, wherein:
light in-coupled by the in-coupler is diffracted as beams along a first path to the first region corresponding to directions of light which will propagate to the first fold grating and a second path to the second region corresponding to directions of light which will propagate to the second fold grating;
the beams incident on the first fold grating are diffracted along a third path to a region corresponding to directions of light which will propagate the first out-coupler and a second out-coupler on the second surface;
the beams incident on the second fold grating are diffracted along a fourth path to the region corresponding to directions of light which will propagate to the first out-coupler and the second out-coupler;
the beams incident to the first out-coupler are diffracted by the first out-coupler along a fifth path to a region corresponding to directions of light which will propagate to the second out-coupler, the second out-coupler then out-couples the light along a path to a user eyebox; and
the beams on the incident to the second out-coupler are diffracted by the second out-coupler along a path to a region corresponding to directions of light which will propagate to the first out-coupler, the first out-coupler then out-couples the light along a path to the user eyebox.

22. The waveguide combiner of claim 8, wherein:
light in-coupled by the in-coupler is diffracted as beams along a path to a first region;
beams incident on the first replicator grating are diffracted along a path to a region corresponding to directions of light which will propagate to the first replicator grating where the beams re-encounter the first replicator grating and are diffracted back to the first region;
the beams diffracted back to the first region encounter the second replicator grating and are diffracted along a path to a region corresponding to directions of light which will propagate to the second replicator grating where the beams are diffracted back to the first region;
the beams diffracted back to the first region by the second replicator grating that are incident to the first out-coupler are diffracted by the first out-coupler along a path to region corresponding to directions of light which will propagate to the second out-coupler, the second out-coupler then out-couples the light along a path to a user eyebox; and
the beams diffracted back to the first region by the second replicator grating that are incident to the second out-coupler are diffracted by the second out-coupler along a path to region corresponding to directions of light which will propagate to the first out-coupler, the first out-coupler then out-couples the light along a path to the user eyebox.

23. The waveguide combiner of claim 14, wherein:
light in-coupled by the in-coupler is diffracted as beams along a path to a first region;
the beams incident on the first replicator grating are diffracted along a path to a region corresponding to directions of light which will propagate to the first replicator grating where the beams re-encounter the first replicator grating 835A and are diffracted back to the first region;
the beams diffracted back to the first region by the first replicator grating incident on the second replicator grating are diffracted along a path to a region corresponding to directions of light which will propagate to the second replicator grating where the beams re-encounter the second replicator grating and are diffracted back to the first region;
the beams incident to the first out-coupler 825A are diffracted by the first out-coupler along a path 851A to a region corresponding to directions of light which will propagate to the expander grating and along a path to a region corresponding to directions of light which will propagate to the expander grating, the expander grating then out-couples the light along paths to a user eyebox; and
the beams incident to are diffracted by the expander grating along a path to a region corresponding to directions of light which will propagate to the first out-coupler and along a path to a region corresponding to directions of light which will propagate to the first out-coupler, the first out-coupler then out-couples the light along paths to the user eyebox.
